(19) United States
(12) Patent Application Publication
(10) Pub. No.: US 2014/0143347 A1
(43) Pub. Date: May 22, 2014

(54) Electronic Message Data Input for Social Graphing

(71) Applicants: Neel Ishwar Murarka, Menlo Park, CA (US); Christopher Turitzin, San Francisco, CA (US); Bryan Guillemette, Palo Alto, CA (US)

(72) Inventors: Neel Ishwar Murarka, Menlo Park, CA (US); Christopher Turitzin, San Francisco, CA (US); Bryan Guillemette, Palo Alto, CA (US)

(21) Appl. No.: 13/679,365

(22) Filed: Nov. 16, 2012

(51) Int. Cl. H04L 12/58

(52) U.S. Cl. CPC H04L 51/32
USPC 709/206

(57) ABSTRACT

In one embodiment, a method includes extracting, by a computing device, information from an electronic message, where the electronic message has been communicated to or from a user of a social-networking system, cross-referencing, by the computing device, the extracted information with social-networking information associated with one or more nodes or edges of the social-networking system, and determining, by the computing device, an action for execution by the social-networking system based on the cross-referencing.

### TECHNICAL FIELD

This disclosure generally relates to Short Message Service (SMS) messages and social-networking systems.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may transmit over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, or laptop computer—may include functionality for wireless communication, such as BLUETOOTH communication, near-field communication (NFC), or infrared (IR) communication or communication with a wireless local area networks (WLANs) or cellular-telephone network. Such a device may also execute one or more applications such as for example, communications through short-message service (SMS), communications through multimedia-messaging service (MMS), accessing e-mail, accessing Internet content, communications through a short-range wireless (e.g. infrared or BLUETOOTH), business applications, gaming, or photography using a camera integrated into the mobile electronic device. With social-networking applications, users may connect, communicate, and share information with other users in their social networks.

### SUMMARY OF PARTICULAR EMBODIMENTS

In particular embodiments, a social-networking system will collect information associated with a Short Message Service (SMS) message, email message, instant messaging service (IM) message, voice-over-IP (VoIP) call, or cellular-network call from a user's mobile device and then cross-reference that information with information associated with the social-networking system's social graph. Based on this cross-reference, the social-networking system can then take actions for the benefit of the user.

In some embodiments, the social-networking system will collect SMS messaging, email messaging, IM messaging, VoIP call, or cellular-network call data and determine the contacts most often contacted by the user. The social-networking system can then use that data to auto-populate suggestions in a social-networking application. In another embodiment, the social networking system may collect data on multi-recipient SMS threads to log information on third-party connections. By cross-referencing contacts appearing in the same SMS thread with user nodes and edges connecting those nodes on a social graph, the social-networking system is able to suggest new friend requests to third parties.

### BRIEF DESCRIPTION OF THE DRAWINGS

FIG. 1 illustrates an example network environment associated with a social-networking system.

FIG. 2 illustrates an example social graph.

FIG. 3 illustrates an example mobile device.

FIG. 4 illustrates an example method for using electronic message data as an input to a social-networking system.

FIG. 5 illustrates an example computer system.

### DESCRIPTION OF EXAMPLE EMBODIMENTS

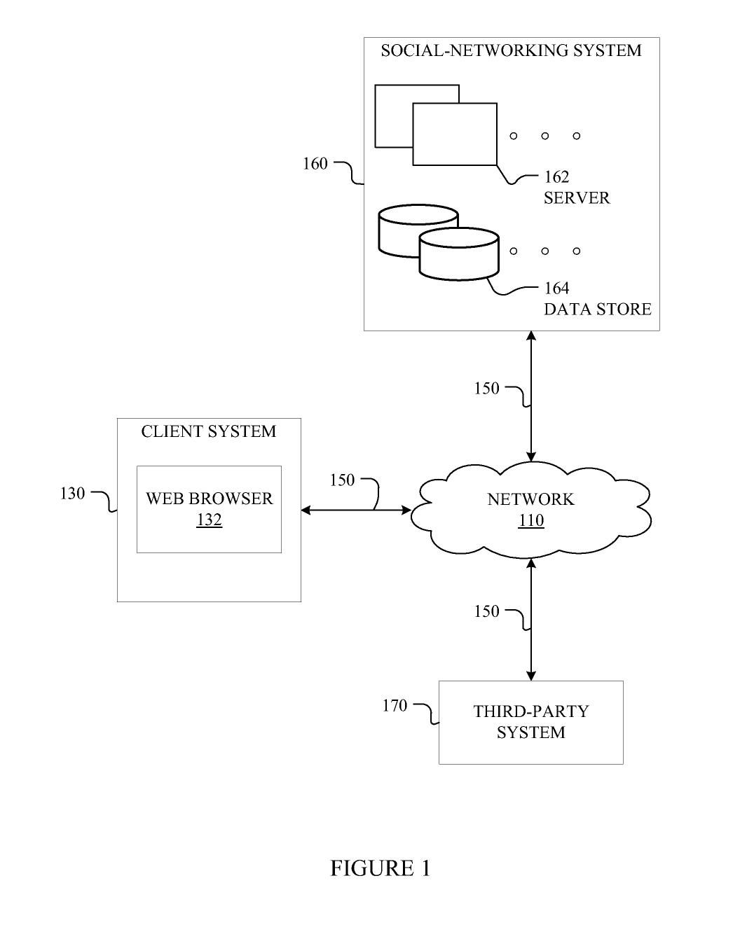

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of client system 130, social-networking system 160, third-party system 170, and network 110, this disclosure contemplates any suitable arrangement of client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client system 130, social-networking systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and transmit social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 164 may include one or more data stores 164. Data stores 164 may be used to store various types of information. In particular embodiments, the information stored in data stores 164 may be organized according to specific data structures. In particular embodiments, each data store 164 may be a relational database. Particular embodiments may provide interfaces that enable a client system 130, a social-networking system 160, or a third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (i.e., relationships) to a number of other users of social-networking system 160 whom they want to be connected to. Herein, the term “friend” may refer to any other user of social-networking system 160 with whom a user has formed a connection, association, or relationship via social-networking system 160.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from a client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, ad-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in or opt out of having their actions logged by social-networking system 160 or shared with other systems (e.g., third-party system 170), such as, for example, by setting appropriate privacy settings. Third-party-content-object stores may be used to store content objects received from third parties, such as a third-party system 170. Location stores may be used for storing location information received from client systems 130 associated with users. Ad-pricing modules may combine social information, the current time, location information, or other suitable information to provide relevant advertisements, in the form of notifications, to a user.

An authorization server may periodically verify information provided by the user. In particular embodiments, the periodic verification may be performed through wireless communication between client system 130 and social-networking system 160. As an example and not by way of limitation, social-networking system 160 or one or more platform applications or external applications may periodically send SMS messages to the telephone number of the client system 130 of a user to determine on an on-going basis whether the telephone number is still valid for the user. As another example, an application on client system 130 may periodically transmit SMS messages to verify the validity of the phone number on an on-going basis. In particular embodiments, the operating system (OS) of client system 130 may give an application supporting social-networking system 160 and executed by client system 130 access to SMS messages received by the client system 130. The application on client system 130 supporting social-networking system 160 may automatically, and without manual input from the user, process the SMS message. As an example and not by way of limitation, the application may process the SMS message to extract information of the senders or recipients of the message. As another example, the application may process the SMS message to detect a particular bit sequence.

Social-networking system 160 may store various types of data. In particular embodiments, such data may be stored in a graph having any number of nodes and edges, where each edge connects two nodes. The graph is often referred to as a “social graph” as it contains, among others, social information.

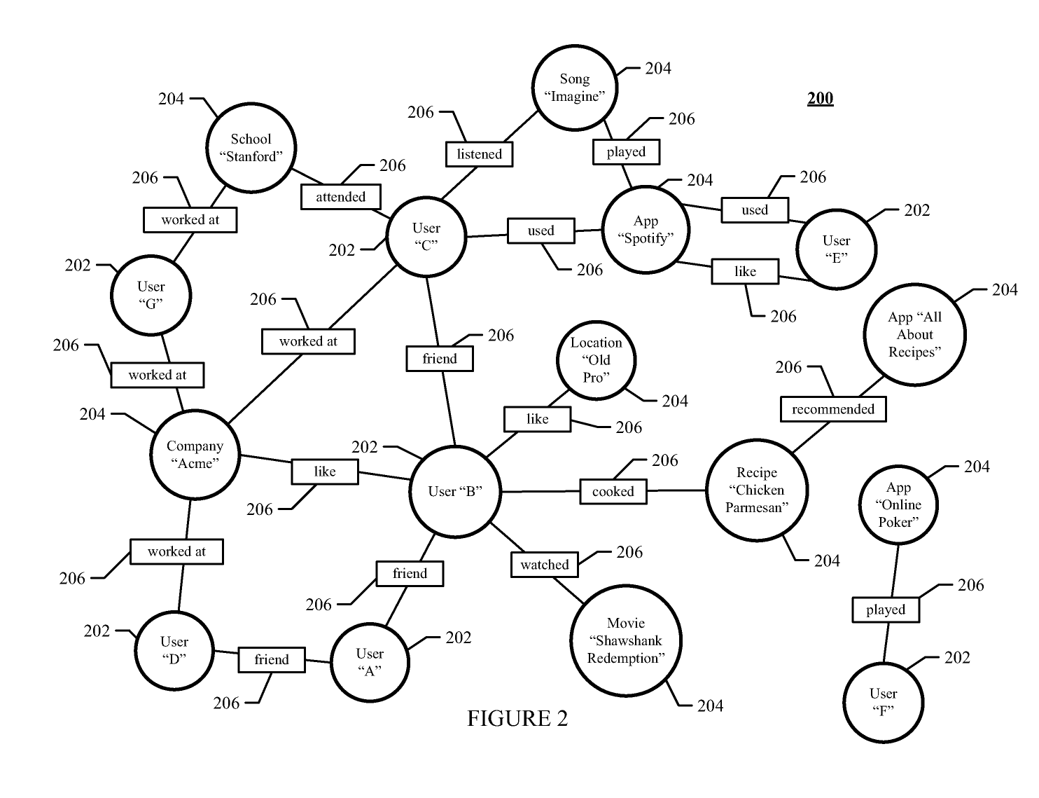

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system 130 to transmit to social-networking system 160 a message indicating the user's action. In response to the message, social-networking system 160 may create an edge (e.g., an “eat” edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may transmit a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 24. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to transmit to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

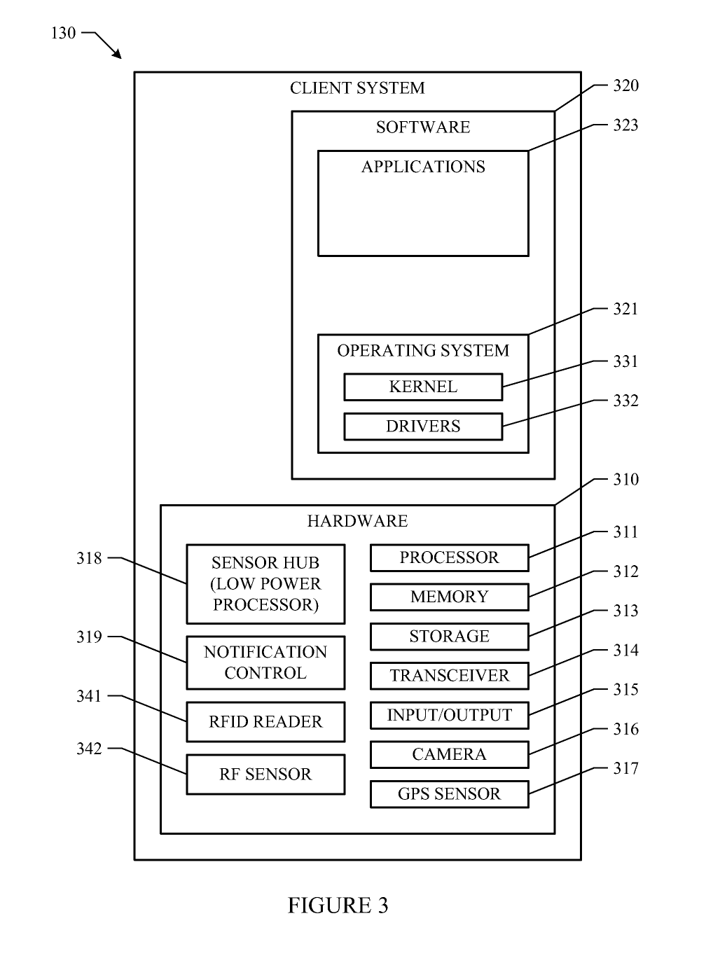

In particular embodiments, a mobile device (e.g., client system 130) may include hardware, firmware, and software. FIG. 3 illustrates an example mobile-device client system 130. In particular embodiments, client system 130 may be a smart phone (e.g., iPhone or Blackberry), which is a mobile telephone that offers more advanced computing ability and connectivity than a traditional mobile phone. It may be considered as a handheld computer integrated with a mobile phone. In particular embodiments, client system 130 may be a netbook or tablet computer (e.g., iPad). In particular embodiments, client system 130 may be connected to a network through a wireless connection.

In particular embodiments, client system 130 may include hardware 310 and software 320. In particular embodiments, hardware 310 may include any number of hardware components such as, for example and without limitation, processor 311, memory 312, storage 313, transceiver 314, input/output device 315 (e.g., display, touch screen, keypad, microphone, speaker, etc.), camera 316, global positioning system (GPS) sensor 317, sensors hub 318, notification control switch 319, radio frequency identification (RFID) reader 341, radio frequency (RF) sensor 342, and so on. This disclosure contemplates any suitable hardware components. In particular embodiments, some or all of a user's user data may be stored in storage 313.

In particular embodiments, software 320 may include an operating system 321, which may include a kernel 331 and/or any number of device drivers 332 corresponding to some of the hardware components available on client system 130. Operating system 321 may be selected for client system 130 based on the actual type of device client system 130 is. For example, if client system 130 is a mobile device (e.g., a smart phone), then operating system 321 may be a mobile operating system such as, for example and without limitation, Microsoft's Windows Mobile, Google's Android, Nokia's Symbian, Apple's iOS, and Samsung's Bada.

In particular embodiments, one or more software applications 323 may be executed on client system 130. In particular embodiments, they may be native applications installed and residing on client system 130. For example, one application (e.g., Google Maps) may enable a device user to view a map, search for addresses and businesses, and get directions; a second application may enable the device user to read, send, and receive emails; a third application (e.g., a web browser) may enable the device user to browse and search the Internet; a fourth application may enable the device user to take photos or record videos using camera 316; a fifth application may allow the device user to receive and initiate VoIP and/or cellular network calls, a sixth application may allow the device user to receive and initiate instant messaging service (IM) messages (e.g., AOL Instant Messenger, ICQ, GChat, iMessage, Facebook Chat), and so on. In particular embodiments, there may be a software application that enables the device user to manage the notifications pushed to client system 130. Each software application 320 may have a user interface and may implement one or more specific functionalities. Each software application 320 may include one or more software modules implementing the individual functionalities. The executable code of software applications 320 may be stored in a computer-readable and non-transitory medium (e.g., storage 313 or memory 312) on mobile device 130.

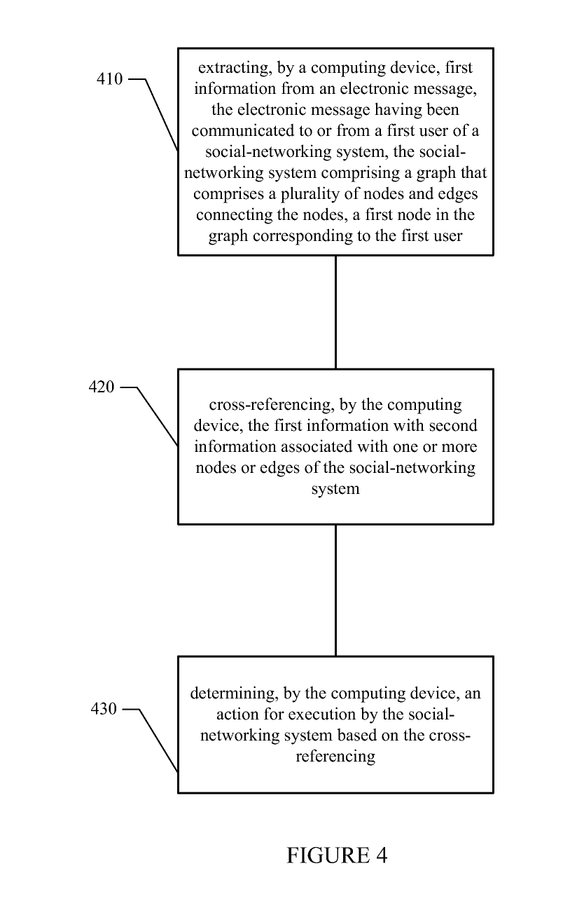

FIG. 4 illustrates an example method 400 for using electronic message data as an input to social-networking system 160. The method may begin at step 410, where a computing device extracts first information from an electronic message. In particular embodiments, the electronic message may be a Short Messaging Service (SMS) message. The SMS message may have been sent to or from a first user of social-networking system 160. That is, the first user may either be the sender or the recipient of the SMS message. In particular embodiments, the first information extracted from the SMS message is the name or phone number of a second user of social-networking system 160 that was a sender or a recipient of the SMS message. In particular embodiments, the first information extracted from the SMS message may be information communicated in the body of the SMS message. The first information in this embodiment may be a name, phone number, email address, physical address, or other identifying information associated with an entity that is not a sender or recipient of the SMS message but may have been mentioned in the body of the SMS message. In particular embodiments, the first information may be received from a mobile computing device of the first user. In particular embodiments, an application on the mobile computing device of the first user may read at least a portion of the SMS message to determine the first information.

In particular embodiments, the electronic message may be an email message. The email message may have been sent to or received by an email messaging client software on client system 130. The email message may have been sent to or from a first user of social-networking system 160. In particular embodiments, the first information extracted from the email message is the name or email address of a second user of social-networking system 160. The first information may be contained in the metadata of the email message. In particular embodiments, the first information may be information communicated in the body of the email message. The first information in this embodiment may be a name, phone number, email address, physical address, or other identifying information associated with an entity that is not a sender or recipient of the email message but may have been mentioned in the body of the email message. In particular embodiments, an application on the mobile computing device of the first user may read at least a portion of the email message to determine the first information.

In particular embodiments, the electronic message may be an instant messaging system (IM) message. The IM message may have been sent to or from a first user of social-networking system 160. The first information may be contained in the metadata of the IM message. In particular embodiments, the first information may be information communicated in the body of the IM message. The first information in this embodiment may be a name, phone number, email address, physical address, or other identifying information associated with an entity that is not a sender or recipient of the IM message but may have been mentioned in the body of the IM message. In particular embodiments, an application on the mobile computing device of the first user may read at least a portion of the IM message to determine the first information.

In particular embodiments, the electronic message may be a VoIP and/or cellular network call. The call may have been initiated by or answered by a first user of social-networking system 160. In particular embodiments, the call may have been received by a voicemail service of the first user. The first information may be extracted from the metadata of the call. In this embodiment, the first information may be caller-identification information specifying the phone number of a second user of social-networking system 160.

In particular embodiments, the first information may be found in the content of the VoIP and/or cellular call. In particular embodiments, the first information may be a name, phone number, email address, physical address, or other identifying information associated with an entity that is not a participant on the call but may have been mentioned by one of the speakers. In this embodiment, speech-to-text software on the client system 130 may be used to extract a textual record of the spoken conversation. In particular embodiments, speech-to-text software may be based on a statistical model capable of outputting a sequence of symbols, such as a Hidden Markov Model, a neural network, an expert system, or any combination thereof. The speech-to-text operation is not limited to the example embodiments described or illustrated above. This disclosure encompasses any combination or permutation of known algorithms, methods, or improvements to algorithms for performing speech-to-text conversion that a person having ordinary skill in the art would comprehend.

In particular embodiments, the first information may be a plurality of voice samples of the speakers on the VoIP and/or cellular call. In this embodiment, the first information may be extracted from the call by software on client device 130 that captures the content of the call. In particular embodiments, this capture may be performed by a voicemail service on client device 130. The plurality of voice samples may be used to identify one or more speakers on the call. In particular embodiments, voice identification software on client device 130 may be used to identify the one or more speakers. In particular embodiments, the voice identification software may be implemented using frequency estimation, Hidden Markov Models, Gaussian mixture models, pattern matching algorithms, neural networks, a matrix representation, Vector Quantization, decision trees, or any combination thereof. The voice identification operation is not limited to the example embodiments described or illustrated above. This disclosure encompasses any combination or permutation of known algorithms, methods, or improvements to algorithms for identifying a speaker based on an audio sample that a person having ordinary skill in the art would comprehend.

In particular embodiments, the extraction of the first information may be limited by global privacy settings of social-networking system 160. For example, the global privacy settings of social-networking system 160 may restrict the gathering of personally identifiable information of all users younger than a given age. As another example, the global privacy settings may restrict the gathering of personally identifiable information of individuals who are not currently users of social-networking system 160.

In particular embodiments, the extraction of the first information may be limited, altered, or precluded by individual user's privacy settings. In particular embodiments, social-networking system 160 may allow users to set privacy settings such as user opt-outs, user opt-ins, data hashing, or data anonymization, as appropriate. For example, the extraction of information from the contents of the electronic message may require an explicit opt-in setting by the first user. As another example, one or more of the parties to the electronic communication may opt-out of collection of personally identifiable information via user privacy settings. In this example, any personally identifiable information associated with those parties would not be stored or used by the computing device. In some embodiments, users may allow collection of personally identifiable information but require that data to be encrypted via data hashing via user privacy settings. For example, the personally identifiable information of one of the speakers on a VoIP call may be extracted and used by the computing device, but the personally identifiable information would be encrypted on the computing device and in any transmissions by the computing device.

At step 420, the computing device cross-references the first information extracted from the electronic message with second information represented by one or more nodes or edges of social graph 200 associated with social-networking system 160. In particular embodiments, each of the nodes or edges associated with the second information is connected to the node representing the first user. In particular embodiments, each edge in the graph represents a single degree of separation within the graph, and each of the nodes or edges representing the second information is connected to the node representing the first user within a pre-determined threshold number of degrees of separation. For example, limiting the cross-referenced second information to information associated with nodes or edges connected to the node corresponding to the first user will allow social-networking system 160 to tailor results to be more responsive to the first user's needs. As further example, limiting the cross-referenced second information to a specified degree of separation can provide an even more responsive list of results.

In particular embodiments, the computing device may compare text strings associated with the first and second information. In particular embodiments, the text string comparison is performed via approximate string matching. In computer science, approximate string matching is the technique of finding strings that match a pattern approximately rather than exactly. Approximate string matching may also be referred to as fuzzy string searching. In approximate string matching, an algorithm calculates the number of primitive operations necessary to convert one text string into an exact match for another text string. Examples of some primitive operations are insertion, deletion, substitution, and transposition. An example of an insertion is transforming “cot” to “coat” by the addition of the letter “A”. An example of a deletion is transforming “coat” to “cot” by the deletion of the letter “A”. An example of a substitution is transforming “coat” to “cost” by the substitution of the letter “S” for the letter “A”. An example of a transposition is transforming “cost” to “cots” by transposing the positions of the letters “S” and “T”.

In particular embodiments, the text string comparison is based on a Levenshtein distance algorithm. A Levenshtein distance algorithm can be used to compute the minimum number of changes in spelling required to transform one word into another. In particular embodiments, the changes in spelling are limited to the primitive operations of insertion, deletion, and substitution. In particular embodiments, the changes in spelling may be any primitive operation discussed above. Mathematically, the Levenshtein distance between two strings a, b is given by lev_{a,b}(|a|,|b|) where

$${lev}_{a , b} ( i , j ) = \{ \begin{matrix}0 , & i = j = 0 \\ i , & j = 0 ⋀ i > 0 \\ j , & i = 0 ⋀ j > 0 \\ min \{ \begin{matrix}{lev}_{a , b} ( i - 1 , j ) + 1 \\ {lev}_{a , b} ( i , j - 1 ) + 1 \\ {lev}_{a , b} ( i - 1 , j - 1 ) + [ {a}_{i} \neq {b}_{j} ] ,\end{matrix} & else\end{matrix}$$

For example, the Levenshtein distance between the word “kitten” and the word “sitting” is three because the minimum number of edits to transform one word into the other is three. One example of operations would be to first substitute the letter “S” for the letter “K”; then substitute the letter “I” for the letter “E”; and finally inserting the letter “G” at the end of the word.

The cross-referencing operation is not limited to the example embodiments described or illustrated above. This disclosure encompasses any combination or permutation of known algorithms, methods, or improvements to algorithms for comparing text strings that a person having ordinary skill in the art would comprehend.

At step 430, the computing device determines an action for execution by social-networking system 160 based on the cross-referencing. In particular embodiments, the action may be creating a connection between nodes in the social graph. For example, social-networking system 160 may create an edge to connect the nodes respectively representing the two users who either sent or received the electronic message. This edge may reflect the fact that these two users have an SMS connection, IM connection, VoIP connection, cellular connection, or email connection. In particular embodiments, the action is contacting one or more users of social-networking system 160. For example, social-networking system 160 may determine that the sender and the recipient of the electronic message are both users of social-networking system 160 but that the nodes corresponding to these users are not connected via an edge indicating that the users are friends. Social-networking system 160 may then contact one or both of the users and suggest that they identify each other as friends within social-networking system 160. In particular embodiments, the action may be automatically selecting social-networking information to provide to a user. For example, social-networking system 160 may determine that the sender and the recipient of the electronic message are both users of social-networking system 160. Social-networking system 160 may then automatically select information associated with the sender of the message and push that data to the recipient of the message. For instance, social-networking system 160 may push the geographic location, photographs, or contact information associated with the sender of the electronic message to the recipient of the electronic message. This would facilitate the exchange of information between known associated users of social-networking system 160

Particular embodiments may repeat one or more steps of the method of FIG. 4, where appropriate. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

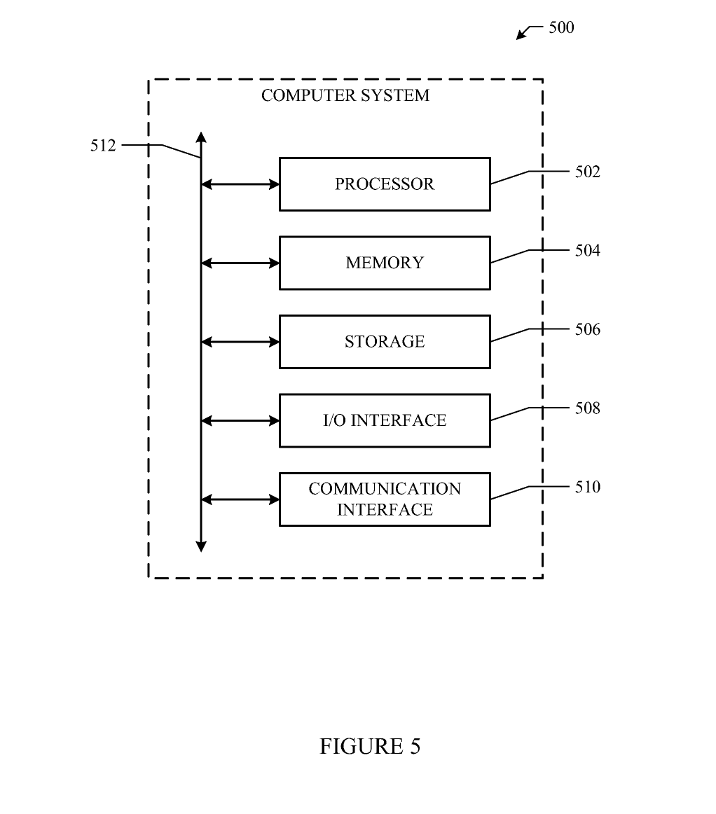

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
extracting, by a computing device, first information from an electronic message, the electronic message having been communicated to or from a first user of a social-networking system, the social-networking system comprising a social graph that comprises a plurality of nodes and edges connecting the nodes, a first node in the social graph corresponding to the first user;
cross-referencing, by the computing device, the first information with second information associated with one or more nodes or edges of the social-networking system; and
determining, by the computing device, an action for execution by the social-networking system based on the cross-referencing.

2. The method of claim 1, wherein the electronic message comprises:
a Short Message Service (SMS) message;
an email message;
an instant messaging service (IM) message;
a voice-over-IP (VoIP) call; or
a cellular-network call.

3. The method of claim 2, wherein the first information is received from a mobile computing device of the first user, an application on the mobile computing device having read at least a portion of the SMS message to determine the first information.

4. The method of claim 2, wherein the first information comprises:
the name of a recipient of the electronic message;
the phone number of a recipient of the electronic message;
the name of a sender of the electronic message;
the phone number of a sender of the electronic message;
the name of an entity contained in the electronic message; or
the phone number of an entity contained in the electronic message.

5. The method of claim 1, wherein:
each of the nodes or edges associated with the second information is connected to the first node.

6. The method of claim 5, wherein:
each edge in the graph represents a single degree of separation within the graph; and
each of the nodes or edges associated with the second information is connected to the first node within a pre-determined threshold number of degrees of separation.

7. The method of claim 1, wherein the cross-referencing, by the computing device, the first information with second information further comprises:
comparing respective name text strings of the second information to a name text string of the first information based on approximate string matching.

8. The method of claim 1, wherein the cross-referencing, by the computing device, the first information with second information further comprises:
comparing respective name text strings of the second information to a name text string of the first information based on a Levenshtein distance algorithm.

9. The method of claim 1, wherein the action comprises:
creating a connection between nodes in the graph;
making a recommendation to the first user;
contacting one or more users of the social-networking system; or
automatically selecting social-networking information to provide to a user.

10. One or more computer-readable non-transitory storage media embodying software that is operable when executed to:
extract, by a computing device, first information from an electronic message, the electronic message having been communicated to or from a first user of a social-networking system, the social-networking system comprising a social graph that comprises a plurality of nodes and edges connecting the nodes, a first node in the social graph corresponding to the first user;
cross-reference, by the computing device, the first information with second information associated with one or more nodes or edges of the social-networking system; and
determine, by the computing device, an action for execution by the social-networking system based on the cross-referencing.

11. The media of claim 10, wherein:
each of the nodes or edges associated with the second information is connected to the first node.

12. The media of claim 11, wherein:
each edge in the graph represents a single degree of separation within the graph; and
each of the nodes or edges associated with the second information is connected to the first node within a pre-determined threshold number of degrees of separation.

13. The media of claim 10, wherein the software is further operable when executed to cross-reference to:
compare respective name text strings of the second information to a name text string of the first information based on approximate string matching.

14. The media of claim 10, wherein the software is further operable when executed to cross-reference to:
compare respective name text strings of the second information to a name text string of the first information based on a Levenshtein distance algorithm.

15. A system comprising:
one or more processors; and
a memory coupled to the processors comprising instructions executable by the processors, the processors being operable when executing the instructions to:
extract, by a computing device, first information from an electronic message, the electronic message having been communicated to or from a first user of a social-networking system, the social-networking system comprising a social graph that comprises a plurality of nodes and edges connecting the nodes, a first node in the social graph corresponding to the first user;
cross-reference, by the computing device, the first information with second information associated with one or more nodes or edges of the social-networking system; and
determine, by the computing device, an action for execution by the social-networking system based on the cross-referencing.

16. The system of claim 15, wherein:
each of the nodes or edges associated with the second information is connected to the first node.

17. The system of claim 16, wherein:
each edge in the graph represents a single degree of separation within the graph; and
each of the nodes or edges associated with the second information is connected to the first node within a pre-determined threshold number of degrees of separation.

18. The system of claim 15, wherein the processors are further operable when executing the instructions to cross-reference to:
compare respective name text strings of the second information to a name text string of the first information based on approximate string matching.

19. The system of claim 15, wherein the processors are further operable when executing the instructions to cross-reference to:
compare respective name text strings of the second information to a name text string of the first information based on a Levenshtein distance algorithm.
